(19) United States
(12) Patent Application Publication
(10) Pub. No.: US 2002/0129383 A1
(43) Pub. Date: Sep. 12, 2002

(54) Apparatus for a cosumer controlled selective recording device for interactive television

(76) Inventor: Louise Mary Wasilewski, Atlanta, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 09/801,958

(22) Filed: Mar. 8, 2001

(51) Int. Cl. H04N 7/16

(52) U.S. Cl. 725/139; 725/135

(57) ABSTRACT

A system for receiving information and for recording at least a portion of the information is described. The system includes a processor (605) for receiving multiple types of information. The processor (605) includes an output port for selectively transmitting the information for recording, an input port for receiving user commands, and a presentation port for transmitting the information for presentation to a user. A presentation device is coupled to the presentation port of the processor for receiving the information and presenting the information to the user. A command unit, which includes a transmitter, is coupled to the input port of the processor for providing recording commands to the processor and also includes an input means for receiving the recording commands from the user. A storage device (645) receives the information to be recorded from the processor, wherein the recording commands indicate to the processor that at least one selected type of information has been selected for storage by the storage device, and wherein, upon reception of a recording command from the user, the command unit transmits the recording command to the processor, in response to which the at least one selected type of information is provided to the storage device, and wherein other non-selected types of information are not provided to the storage device for recording.

### FIELD OF THE INVENTION

This invention relates generally to a consumer controlled selective recording device, and more particularly to a selective recording device that parses Moving Pictures Experts Group (MPEG) table data or program guide information in systems delivering MPEG formatted data signals to system subscribers.

### BACKGROUND OF THE INVENTION

There are several systems that transmit television signals to system subscribers, such as broadband cable, satellite, and digital subscriber line (DSL) systems. Broadband systems, such as cable television systems, typically include a headend for receiving programming information from various sources and redistributing the programming information to subscribers. Providing a program to a transmitter directly from the recording studio can additionally provide programming information to a subscriber. The headend receives programming signals from a variety of sources, combines the programming signals from various sources, and transmits the combined signals to subscriber equipment. The distribution system can include a variety of media, such as coaxial cable, fiber optic cable, wireless, and satellite links. In a cable television system, the subscriber equipment, which receives the signals from the headend, can include a cable-ready television, a cable-ready video cassette recorder (VCR), a tapeless digital VCR, or a digital home communications terminal (DHCT) that is connected to a television, computer, or other display device.

The headend uses modulators to control the stream of data into the distribution system. In today's competitive market, the modulators must be able to accept data from equipment manufactured by many different suppliers. Increasingly, the headend is receiving and transmitting programming in a digital, for example, Moving Pictures Expert Group (MPEG), format. Transmitting programs in MPEG format is advantageous because several digitized programs can be combined and transmitted in the same 6 mega Hertz (MHz) of bandwidth that is required to transmit a single analog channel or program.

MPEG bit streams include overhead information such as MPEG tables that indicate the types and location of the programming. In a local television system, the MPEG tables include information that is specific to that local distribution system and its particular channel line-up. MPEG, as referenced herein, is described in the MPEG-1 and MPEG-2 standards. The MPEG-1 standards (ISO/IEC 11172) and the MPEG-2 standards (ISO/IEC 13818) are described in detail in the International Organization for Standardization document ISO/IEC JTC1/SC29/WG11 N (June 1996 for MPEG-1 and July 1996 for MPEG-2 ), which is hereby incorporated by reference. Therefore, the headend system, and the modulators or multiplexers, add the required MPEG table data to the outgoing bit stream.

Traditionally, the subscriber records an event with a recording device, such as a VCR or a personal video recording (PVR) device, by programming the device to accept a particular piece of the information, such as an event on a specific channel. These prior art devices record all the information associated with the event. More specifically, video, audio, and data, if available, are recorded with the recording device. While recording the entire information package may not pose a tremendous problem to the subscriber, the recording device has limited memory space for recording and saving a limited number of events. The subscriber has to supply additional cassettes or continue to delete previously recorded information to allow memory space for additional events. Additionally, the cable television system has to provide the entire information content to the subscriber, thereby using the entire bandwidth that is required for the transmission of video, audio, and data streams associated with the event.

Thus, what is needed (but that is not available in known devices or prior art) is a device that records only the specific parts of events or information that the subscriber wishes to record, such as just the video and data streams, for example. In addition, an opportunity exists to provide a device that can be used to aid the cable operator in saving bandwidth by supplying only the specified information that the subscriber wishes to record, and not the entire content for an event, in the case of an on-demand situation.

### BRIEF DESCRIPTION OF THE DRAWINGS

FIG. 1 is a block diagram of a cable television system in which the present invention may be employed.

FIG. 2 is a block diagram representation of an MPEG transport packet.

FIG. 3, consisting of FIG. 3A and FIG. 3B, illustrates the relationship between MPEG tables and an MPEG transport stream.

FIG. 4 is a block diagram representation of a modulator for modulating MPEG bit streams.

FIG. 5 illustrates an example interactive viewing screen for recording options in accordance with the present invention.

FIG. 6 is a block diagram of a selective recording device in accordance with the present invention.

FIG. 7 illustrates an example interactive viewing screen for naming an event in accordance with the present invention.

FIG. 8 illustrates an example interactive viewing screen for selecting a recorded event in accordance with the present invention.

### DETAILED DESCRIPTION

The present invention provides a method and apparatus that receives control signals from a subscriber via an interactive viewing screen shown on a television or other display device that indicates choices made by the subscriber. The choices reflect the exact content streams of a transmission event or an on-demand media event to be recorded via a selective recording device (SRD). In an exemplary embodiment, the present invention provides a dynamic method for allowing the subscriber to choose specific content, e.g., voice and data streams, within an event to be recorded, in response to which the SRD adaptively controls packets within an MPEG transport stream for delivering and recording just the specified content. This embodiment describes a device that includes a processor and a storage device among other components. The processor within the SRI) determines at least one packet identifier (PID) identifying associated packets within the transport stream and records those packets in the storage device.

Referring now to the drawings, in which like numerals represent like elements throughout the several figures, the present invention and an exemplary operating environment will be described.

Television System Overview

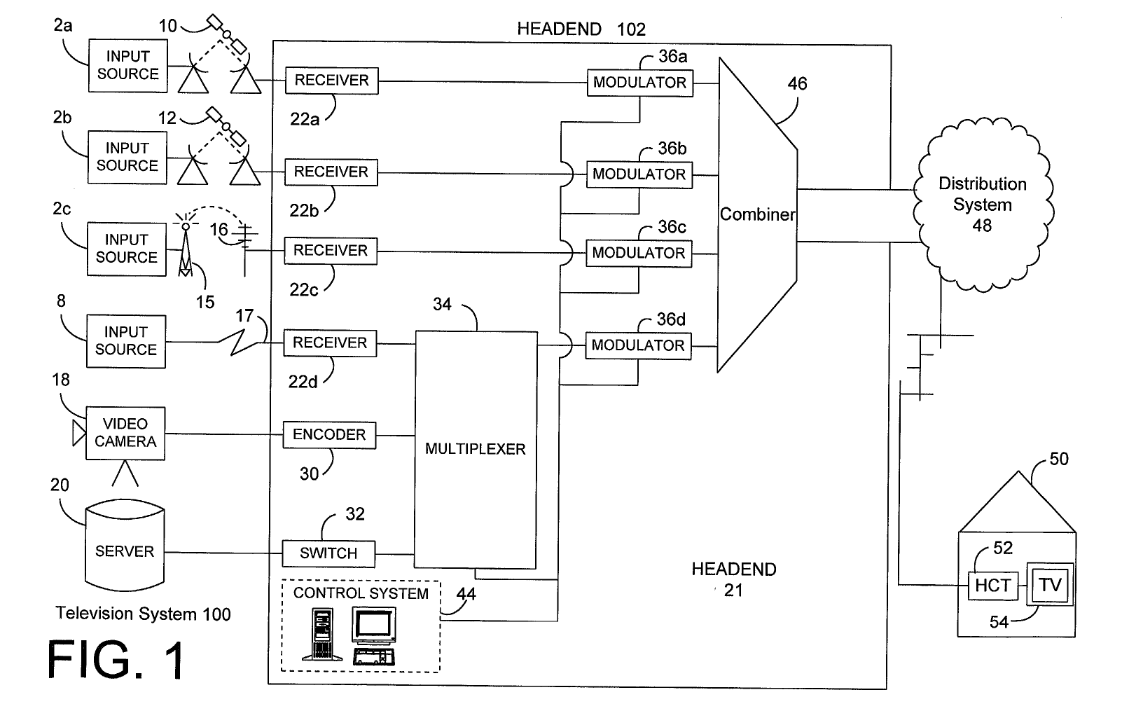

FIG. 1 illustrates various aspects of an exemplary cable television system in which the present invention is designed to operate. Those skilled in the art will understand that while digital equipment and signaling are highlighted in the following examples, analog and combinations of analog and digital of equipment and signaling can be used throughout a television system. For example a modulated output signal could be an analog signal.

The television system 100 includes a headend 21, which receives input programming from multiple input sources. The headend 21 combines the programming from the various sources and distributes the programming to subscriber locations (e.g., subscriber location 50) via distribution system 48.

In a typical system, the headend 21 receives programming from a variety of sources 2a, 2b, 2c. The programming signals may be transmitted from the source to the headend via a variety of transmission paths, including satellite paths 10, 12, and terrestrial broadcast paths 15, 16. Additionally, the programming signals could be sent directly to the receiver. The headend can also receive programming from a direct feed source 8 via a direct line 17. Other input sources include a video camera 18 or a server 20. The signals provided by the programming sources can include a single session or a multiplex that includes several sessions.

Programmers and television system operators both employ forms of conditional access, or encryption, to prevent piracy and ensure that those that have subscribed to and paid for their services are only receiving their signals. For example, programmers employ conditional access to ensure that those television system operators that pay for their programming only decrypt their transmissions. Similarly, television system operators can use conditional access to prevent “pirates” from receiving premium channels or pay per view programming that they have not paid for. Thus, a signal from a programmer may be decoded using “incoming” conditional access, and then encoded for transmission to the subscribers using “outgoing” conditional access. An example of a conditional access system that may be used in television system 100 is disclosed in commonly assigned, co-pending U.S. patent application Ser. No. 60/054,575 filed Aug. 1, 1997, entitled “Conditional Access System”, the disclosure of which is incorporated herein by reference.

The headend 21 includes a plurality of receivers 22a, 22b, 22c, 22d that are each associated with an input source. MPEG encoders such as encoder 30, are included for encoding such things as local programming or a video camera feed. A switch 32 provides access to server 20, which could be a pay-per-view server, a data server, an Internet router, a network system, or a telephone system. Some of the signals may require additional processing, such as signal multiplexing prior to being modulated. Such multiplexing is done by multiplexer 34.

The headend 21 contains a plurality of modulators, 36a, 36b, 36c, and 36d, for interfacing to the distribution system 48. The modulators convert the received programming information into a modulated output signal suitable for transmission over the distribution system 48. The output signals from the modulators are combined, using equipment such as a combiner 46, for input into the distribution system 48.

A control system 44 allows the television system operator to control and monitor the functions and performance of the television system 100. The control system 44 interfaces, monitors, and/or controls a variety of functions, including the channel lineup for the television system, billing for each subscriber, and conditional access for programming distributed to subscribers. Control system 44 provides input to the modulators for setting their operating parameters, such as system specific MPEG table packet organization or conditional access information. The control system 44 can be located at headend 21 or remotely.

The distribution system 48 distributes signals from the headend 21 to subscriber locations, such as subscriber location 50. The distribution system 48 could be an optical fiber network, a coaxial cable network, a hybrid fiber-coaxial network, a satellite system, or a direct broadcast system. There is a multitude of subscriber locations connected to distribution system 48. At subscriber location 50, a decoder 52, such as a digital home communications terminal (DHCT), decodes the signals for display on a display device, such as on a television set (TV) 54 or a computer monitor. Those skilled in the art will appreciate that the signal can be decoded in a variety of equipment, including a DHCT, a computer, a TV, a monitor, satellite receiver, or digital VCR.

Moving Pictures Experts Group (MPEG) Overview

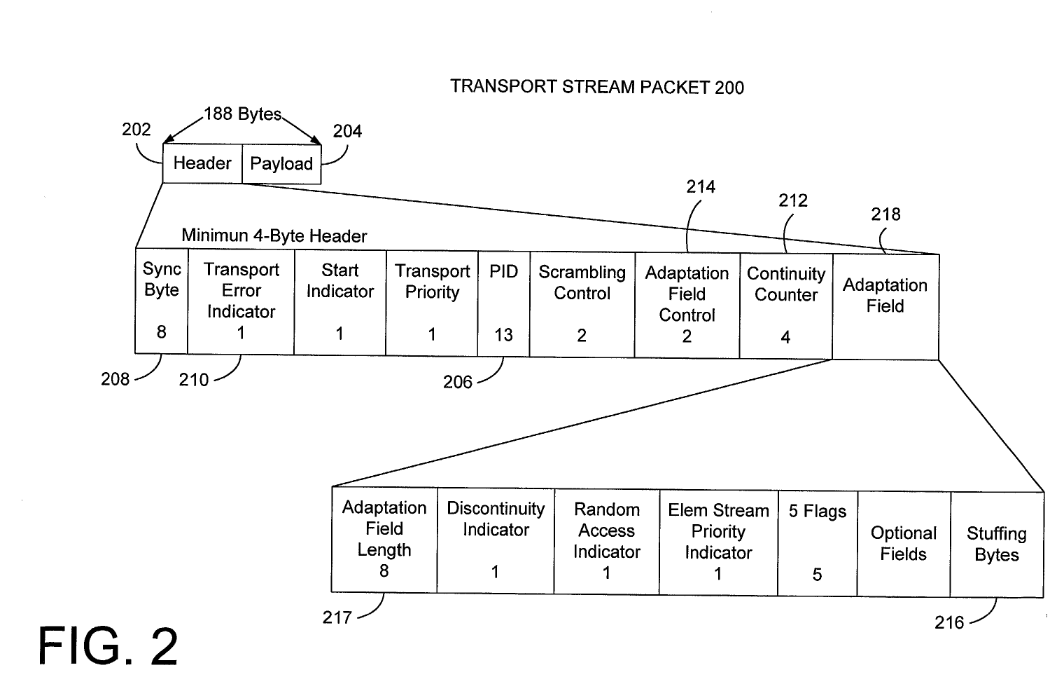

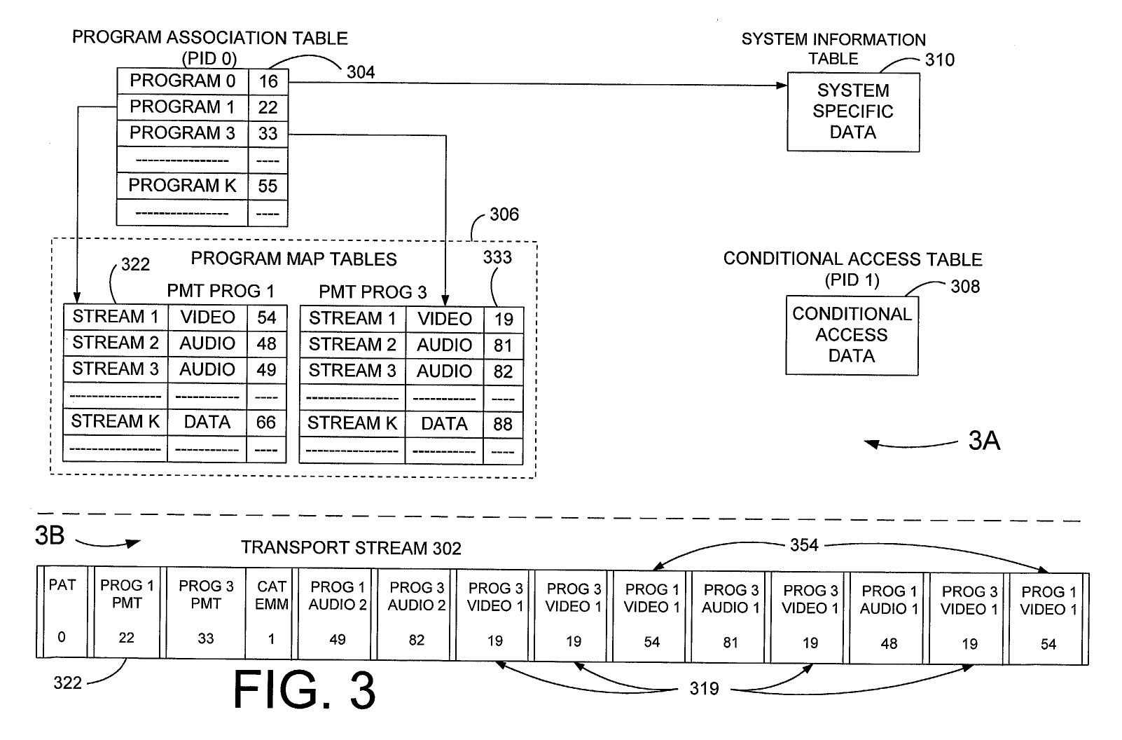

The Moving Pictures Experts Group (MPEG) was established by the International Standards Organization (ISO) for the purpose of creating standards for digital audio/video compression. The MPEG experts created the MPEG-1, MPEG-2, and MPEG-4 standards, with the MPEG-1 standard being a subset of the MPEG-2 standard. The combined MPEG-1, MPEG-2, and MPEG-4 standards are hereinafter referred to as MPEG. In an MPEG encoded transmission, programming and other data are transmitted in packets, which collectively make up a transport stream. An MPEG transport stream includes table packets, which provide information about the organization of the transport stream and about any conditional access scheme that is used. Additional information regarding transport stream packets, the composition of the transport stream, types of MPEG tables, and other aspects of the MPEG standards are described below. In addition, FIG. 2 and FIG. 3 provide a graphical representation of MPEG information. In an exemplary embodiment, the present invention employs MPEG table packets. However, the present invention is not so limited, and can be implemented using other types of data, for example, data provided as part of a program guide. As mentioned above, an MPEG transport stream is made of packets, where each packet is identified by a packet identifier (PID). All of the packets associated with a single source, for example, all video packets or all audio packets for a source, will include the same PID. In general, table packets are used to indicate which PIDs are associated with each program in the transport stream. So, for example, a table packet might indicate that the transport stream includes two programs, where program 1 consists of the packets with a PID of 31, for example, a radio program; and program 2 consists of the packets with a PID of 45 and 63, for example, a television program including video 45 and audio 63. Additional information regarding the makeup of an MPEG transport stream and its various components is provided below.

Packetized Elementary Stream (PES)

The output of a single MPEG audio or video encoder 30 (of FIG. 1) is an Elementary Stream, which is an endless, near-real-time signal. The Elementary Stream is broken into packets in what is referred to as a Packetized Elementary Stream (PES). These packets include header information to identify the start of the packets and must include time stamps because packetizing disrupts the time axis.

One video PES and a number of audio PESs can be combined to form a program, provided that all of the encoders are locked to a common clock. Time stamps in each PES ensure correct correlation, or lip-sync, between the video and audio. Data may also be included with or without time stamps.

Transport Stream Packet

A Transport Stream is a multiplexed stream that may include several programs, which are transported in fixed size, 188 byte, transport stream packets 200 (FIG. 2). FIG. 2 illustrates a transport stream packet 200, including a minimum 4 byte header 202 and a payload 204. The header 202 is further expanded to illustrate the parts thereof. The numbers at the bottom of the cells, such as the 8 in Sync Byte field 208, indicate the fixed bit size of the cell. Cells with no number, such as payload 204, do not have a fixed size. In header 202, the most important information is:

Sync Byte cell 208, which is recognized by a de-multiplexer or decoder so that alignment to the start of a packet can be determined.

Transport error indicator cell 210, which is set if the error correction layer above the transport layer is experiencing a raw bit error rate (BER) that is too high to be correctable. It indicates that the packet may contain errors.

Packet Identifier (PID) cell 206, which is a thirteen-bit code used by a de-multiplexer or decoder to distinguish between different types of packets.

Continuity counter cell 212, which is a four-bit value that is incremented by the encoder as each new packet having the same PID is sent. It is used to determine if any packets are lost, repeated, or out of sequence.

Header 202 also includes a start indicator cell, a transport priority cell, a scrambling control cell, an adaptation field control cell 214, and an adaptation field cell 218. The start indicator cell is used, among other purposes, to indicate the presence of the beginning of a table in certain packets. Included within the adaptation field cell 218 is an adaptation field length cell 217, a discontinuity indicator cell, a random access indicator cell, an elementary stream priority indicator cell, a 5 flags cell, an optional fields cell, and a Stuffing Bytes cell 216.

In some cases more information is needed in header 202. The header can be expanded using adaptation field cell 218. If header 202 is expanded, payload 204 becomes smaller to maintain the fixed packet size of 188 bytes.

Stuffing Packets

When the required bit rate or packet size is less than the fixed bit rate or fixed packet size, the excess capacity is filled by inserting stuffing. Stuffing can be used in two ways, as stuffing bytes or as a stuffing packet. Stuffing bytes can be used with a partial payload to fill up the remainder of transport stream packet 200 to maintain the fixed packet size. Stuffing bytes can be in the payload 204 or in the Stuffing Bytes cell 216 of an expanded header 202. A stuffing packet, which is a transport stream packet 200 with only a header and stuffing, can be used in a fixed rate bit stream to maintain the fixed bit rate. The stuffing packet is used to fill unused or excess capacity. Stuffing packets are always identified by PID 8191, or thirteen 1s. Demultiplexers and decoders ignore packets thus identified as stuffing packets. Stuffing can be all ones (1), all zeros (0), pseudo-random 1s and 0s, or an ignore flag followed by any of the other options.

Transport Stream (TS)

Several programs and their associated PESs are multiplexed to form a single Transport Stream (TS) 302 (FIG. 3). A Transport Stream 302 differs from a program in that the PES packets are further subdivided into short fixed-size (i.e., 188 byte) transport stream packets 200 and in that multiple programs encoded with different clocks can be carried. This is possible because a transport stream 302 has a program clock reference (PCR) mechanism that allows transmission of multiple clocks.

The fixed-size transport stream packets 200 of Transport Stream 302 each contain 188 bytes. The transport stream 302 may carry many different programs. In advanced applications, each program may use a different compression factor and a bit rate that can change dynamically even though the overall bit rate for Transport Stream 302 may stay constant. Called statistical multiplexing, this advanced application allows a program temporally requiring a larger bandwidth to borrow bandwidth from a program that is not using all of its allocated bandwidth. In addition, each video PES could have a different number of audio and data PESs associated with it. With this flexibility in the make-up of Transport Stream 302, a decoder or demultiplexer must be able to change from one program to the next and correctly select the appropriate audio and data channels. This changing and selecting is facilitated by MPEG tables described herein below.

A Transport Stream 302 is more than just a multiplex of audio and video packets. In addition to the compressed audio, video, and data, Transport Stream 302 includes a great deal of information that describes the bit stream. This information is found in MPEG tables such as Program Specific Information tables or System Information tables, which describe the relationships of the MPEG packets and identify their corresponding packet identifier (PID), in which some of this information may or may not be presented to the subscriber. Each packet carries a PID 206 (see FIG. 2) located in the packet header 202. The MPEG tables list the PIDs for all packets associated with a particular program. The PIDs are used by the decoder or demultiplexer to change from one program to the next and correctly select the appropriate video, audio, and data channels.

FIG. 3, including FIG. 3A and FIG. 3B, illustrates the relationship between the transport stream 302, the MPEG packets and tables therein, and the function of PIDs. Illustrative of the function of PIDs, they can be used to locate the associated tables in FIG. 3A or the corresponding packets in FIG. 3B.

FIG. 3A, the upper portion of FIG. 3, represents the different MPEG tables in the MPEG transport stream 302. For example, Program Association Table 304 indicates that packets with a PID of 22 may contain Program Map Tables (PMT) associated with program 1. The PMT 322 that has a PID of 22 indicates the PIDs of the packets that make up the various components of the stream associated with program 1.

FIG. 3B, the lower portion of FIG. 3, represents the MPEG packets found in a typical MPEG transport stream 302. The MPEG packets are labeled and display their corresponding PIDs. The PIDs can identify an associated table of FIG. 3A. For example, in FIG. 3B, the packet 322, which has a PID of 22, corresponds to the PMT 322 of FIG. 3A.

Program Specific Information (PSI)

A demultiplexer or decoder can correctly select packets only if it can correctly associate them within the transport stream 302 to which they belong. A demultiplexer or decoder can do this task only if it knows what the right PIDs are. This is the function of the Program Specific Information (PSI) tables.

The PSI includes the Program Association Table (PAT) 304, the Conditional Access Table (CAT) 308, and the Program Map Table (PMT). In FIG. 3A two PMTs are shown, Program 1 PMT 322 and Program 3 PMT 333.

The PSI tables are carried in packets having unique PIDs, some of which are standardized and some of which are specified by the PAT 304 and the CAT 308. These table packets must be repeated periodically in every transport stream. The PAT 304 always has a PID of 0, the CAT 308 always has a PID of 1, and stuffing packets always have a PID of 8191. These are the only fixed PIDs in the MPEG system; although, some other PIDs may not be used for certain purposes according to the MPEG standards. The demultiplexer or decoder must determine all of the remaining PIDs by accessing the appropriate table(s).

The Program Association Table (PAT) 304 lists every program in transport stream 302. The PAT 304 identifies the PID for the packets containing the associated Program Map Tables (PMT) 306. For example, PAT 304 identifies all packets with PID 22 as being a PMT 322 associated with program 1.

PIDs of all video, audio and data elementary streams that belong in the same program stream are listed in a PMT 306 with their associated PIDs. For example, PMT 322 lists a video stream, two audio streams, a data stream, and other elementary streams belonging to program 1. PMT 322 also identifies the associated PIDs for each stream, such as PID 54 for all program 1 video packets.

In FIG. 3, the PAT 304 identifies PID 33 for all program 3 PMT 333 packets. In the corresponding PMT 333, elementary stream 1 identifies as a video stream all packets with a PID value of 19. All program 3 video 1 packets, in transport stream 302, have PID 19 as indicated by arrows 319 of FIG. 3B. PMT 322 indicates that all video packets associated with program 1 have PID 54. These packets are indicated by arrows 354 in transport stream 302 of FIG. 3B. The decoder (or a demultiplexer) can select all data for a given elementary stream by accepting only packets with the right PID, such as PID 19 for elementary stream 1 video, and rejecting the remainder. Data for an entire program can be selected using the PIDs in a PMT. For example, for the entire program 3, using PMT 333, select all video 19 PIDs, audio 81 PIDs, audio 82 PIDs, and data 88 PIDs. Packet-continuity counts ensure that every packet that is needed to decode a stream is collected.

In some systems, some or all of the programs are protected or tiered so that those who have paid a subscription or fee can only view them. Then the transport stream 302 contains conditional access information, Conditional Access Table (CAT) 308, to administer this protection, located at PID 1 and labeled EMM in transport stream 302. The PIDs for Entitlement Management Messages (EMM) are listed in the CAT 308 packets (PID=1).

Consequently, if the decoding of a particular program is required, reference to the PAT 304 and then a PMT 306 is all that is needed to find the PIDs of all of the elementary streams in the program. If the program is encrypted, then access to the CAT 308 may also be necessary.

The first entry in the PAT 304, session 0, indicates the PID of the System Information Table 310.

System Information Table

A given System Information Table 310 contains details of more than just the transport stream 302 carrying it or the PSI of the transport stream. The System Information Table 310 may also include details of other transport streams that may be available to the same decoder, for example, by tuning to a different RF channel or steering a dish to a different satellite. The System Information Table 310 may list a number of other transport streams and each one may have a descriptor that specifies the radio frequency, orbital position, and so on. System Information Table 310 provides information describing the overall system signal(s) of a specific television system 100.

Types of a System Information Table 310 include a Digital Video Broadcast (DVB) standard Network Information Table (NIT) and an Advanced Television Systems Committee (ATSC) standard System Information (SI) table. DVB and ATSC transport streams may also contain additional service information.

Those skilled in the art will appreciate that FIGS. 1-3 are intended to provide a brief, general description of a typical television system and MPEG encoded data, and that additional information is readily available from a variety of sources.

Modulator Overview

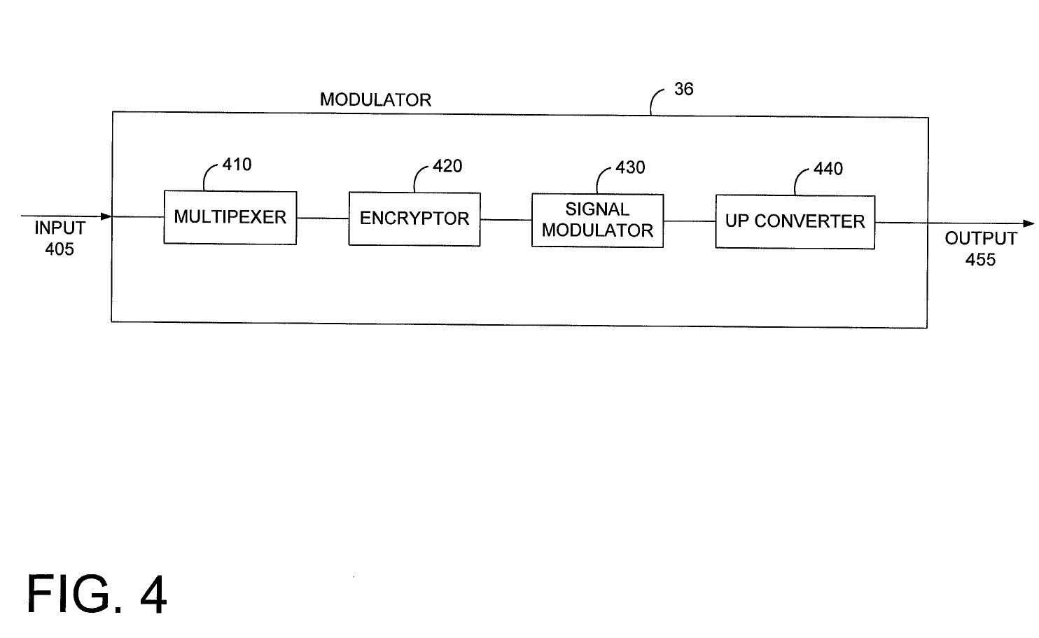

FIG. 4 is a block diagram of a modulator (such as modulator 36), which is located in headend 21 of television system 100 (FIG. 1). The block diagram is a representation of a modulator for modulating MPEG transport stream 302 (FIG. 3). The modulator 36 includes a multiplexer 410 for receiving and modifying an input signal 405. Modifying the input signal 405 includes extracting incoming MPEG table information, which is part of the present invention. The modulator 36 also includes an encryptor 420 for encrypting the bit stream, a signal modulator 430 for modulating the bit stream, and an up converter 440 for producing output 445.

An Exemplary System for a Selective Recording Device for Interactive Television

The present invention is directed to a method and a selective recording device (SRD) for receiving input typically via an interactive viewing screen shown on a television or other display device that allows a subscriber to choose the exact information to be recorded via the selective recording device. The present invention will be described more fully hereinafter with reference to the accompanying drawings in which like numerals represent like elements throughout the several figures, and in which an exemplary embodiment of the invention is shown. This invention may, however, be embodied in many different forms and should not be construed as limited to the embodiment set forth herein; rather, the embodiment is provided so that this disclosure will be thorough and complete, and will fully convey the scope of the invention to those skilled in the art.

Briefly, the selective recording device (SRD) in accordance with the present invention offers the subscriber recording options. For example, the subscriber may wish to record in the conventional manner by recording only video and audio. In accordance with the present invention the subscriber may, however, choose to select just particular streams associated with the programming, such as just the audio stream or just the video stream; in addition, the subscriber may choose to record any data associated with an event and record neither the video nor audio. As reviewed in the MPEG overview reference above, there are several facets that comprise a program, or channel, and they vary with the different programs; however, some content examples within a program may be video, audio-English, audio-Spanish, data in HTML, and closed captioning. An originator initially produces an event, such as a sports event or a documentary, and programs the event to include various content streams, for example, video, audio, and data packets. The events are sold to or produced for service providers, such as HBO or Turner Broadcasting. A cable operator receives the programs from service providers and further defines and groups the programs and their associated packets within MPEG stream tables, such as the PAT and PMT. The tables are then sent downstream to the appropriate subscribers for viewing. It will be appreciated that the programs can also be transmitted directly to a subscriber who receives television signals over the air.

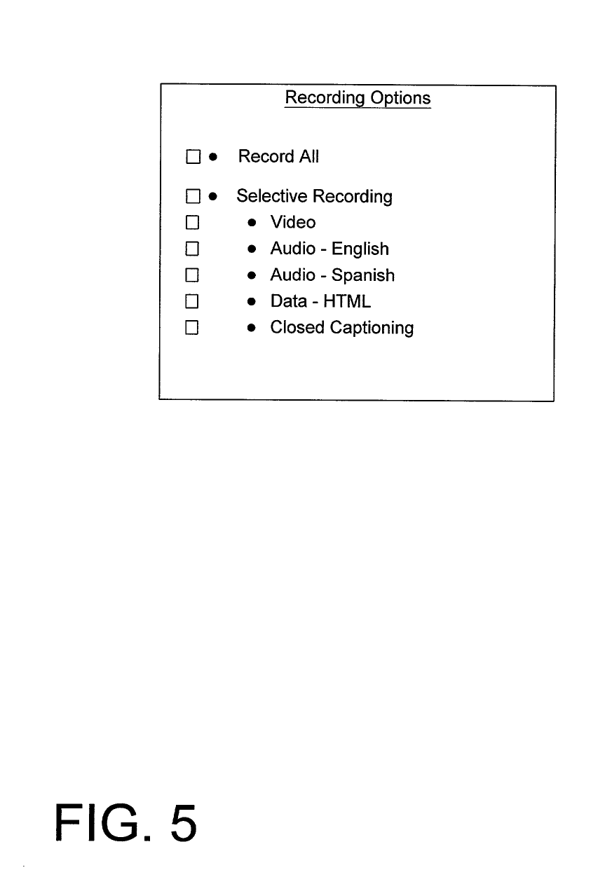

FIG. 5 illustrates an example of an interactive viewing screen shown on a communication medium, such as a television or a computer, that a subscriber may use to choose specific streams of an event that is to be recorded. The subscriber may use a control device, such as a remote control, mouse, or touch screen, that controls the communication medium, to select the desired option or options. By way of example, if a hearing-impaired subscriber wishes to record just the video and closed captioning, the subscriber may select just those two streams associated with the event. Another example is if a subscriber wishes to record the data streams, such as a hypertext markup language (HTML) file including, for example, a recipe or movie review, that is being sent with an event, then the data stream can be selected so that just that portion of the event is recorded. The screen shown in FIG. 5 is a dynamic screen that may change with each event depending upon the event's available content streams. Available content may be determined in real-time from the PSI table or in advance, if this information is carried in a program guide. The selective recording device in accordance with the present invention may display on the interactive viewing screen just the available streams from which the subscriber is permitted to choose.

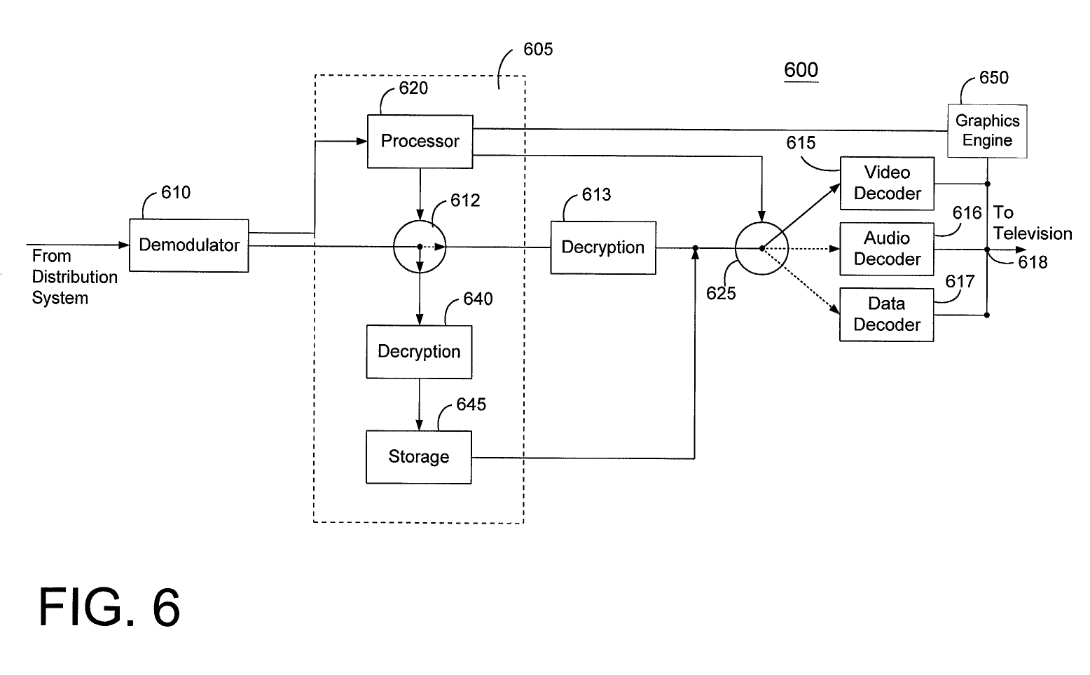

FIG. 6 illustrates an exemplary embodiment of the selective recording device (SRD) 605 that may be located within a digital home communications terminal (DHCT) 600 located at the subscriber's premises. It will be appreciated that the SRD 605 can also be included within a television, computer, or other consumer electronics device. Alternatively, the SRD 605 can be a stand-alone unit, in which case the SRD 605 includes an input/output port that can be connected to a conventional DHCT or directly to the communication medium, e.g., the display device. In the embodiment shown in FIG. 6, a demodulator 610 receives all the content streams in the form of a transport stream from the headend of a broadband communications system. The demodulator 610 tunes the DHCT 600 to a particular channel by accessing the MPEG tables and allowing the chosen content streams associated with that channel through a switch 612 and, when recoding is not in use, a decryption device 613. The decryption device 613 is used if the channel is encrypted. A processor 620 also receives the MPEG table data, for example, the PSI tables, within the demodulated transport stream and determines which content streams are available for the tuned event. When recording is not in use, the processor 620 controls a switch 625 so that the content streams pass through the switch 625 to decoders. A video decoder 615, an audio decoder 616, and a data decoder 617 receive the respective content streams and provide them to output 618. The content streams associated with the selected channel are then shown on the presentation device, such as a television or other display device.

When the user wishes to record content, the processor 620 controls the switch 612, so that the chosen content streams pass through decryption device 640 and are then captured in storage 645. When the user requests playback of stored information, the content is routed from the storage 645 to the switch 625 and then through to the relevant decoders 615, 616, 617, before presentation 618. In practice, decryption device 613 and decryption device 640 may be the same device. The recording process is described below in further detail.

When the user wishes to record, the information received by the processor is provided to the user, preferably, text descriptions of the content streams are shown on the screen as the choices that are, for the associated event, available to record. By way of example, the processor 620 determines from PSI, SI, or IVG information that a specific event either currently shown or an event that will be shown in the future on a specific channel has video, audio in two languages, and data available to record. This information is presented to a graphics engine 650 and the output combined, typically by overlay, with the video decoder output for viewing and subsequent interaction on the screen or other display device, such as a remote control or portable computer display. It will be appreciated that the recording options may be shown to the subscriber, but are preferably displayed in response to prompting by the subscriber. The subscriber could, for example, select to put the DHCT 600 into a menu mode in which selective recording options may be viewed (see FIG. 5 for example).

The content streams that are available to record, which are shown as the options displayed on the Recording Options screen (FIG. 5), are determined within the processor 620 by parsing the MPEG tables within the transport stream that is received in the demodulator 610. Again, the program specific information (PSI) table describes the relationships of the MPEG packets and identifies their corresponding packet identifiers (PIDs). The MPEG tables list the PIDs for all packets associated with a particular program, or event. Content streams for an entire program or event can be selected by choosing the descriptive text that is indicative to the PIDs in a program map table (PMT). Similar content stream structures may be included in interactive viewing guide (IVG) data, enabling the same processes of the exemplary embodiment of the present invention. Selected streams within a program can also be shown as descriptive text by using the PIDs in a program map table (PMT). Referring again to FIG. 3 as an example, the processor 620 parses the program association table (PAT) to determine the definition for the specific chosen program, for example, program 3. Then the processor 620 parses the associated PMT to determine all the content streams available and their associated packet identifiers for that event, shown as PMT program 3 333. Once the processor 620 has identified all the available content streams, the processor 620 activates the display device to display choices that are indicative of the available content streams. These choices are preferably displayed on the Recording Options screen either automatically or in response to receiving a command from the subscriber. In one example, the Recording Options screen displays availability for video, two audio languages, and data, such as closed captioning.

The subscriber can view the descriptions of the content streams that can be recorded by accessing a recording options screen (FIG. 5) while viewing an event on a channel by pressing a recording options button that is, for example, a button on a remote control. Alternatively, an icon could be shown in a corner or other location of the viewing picture, and the subscriber could press an “icon” button on the remote control to trigger display of the recording options screen. The screen then displays the information describing recording options associated with that particular event. It will be appreciated that another option is to view the recording options screen (FIG. 5) from the IVG that displays all available events on all channels over an extended period of time. An event can be highlighted on the IVG, and the recording options button, screen, or icon can be activated. The processor 620 then would receive an activation signal from the remote control and would tune the demodulator 610 to access the content streams included within that particular event. This can be repeated for all interested events.

Once a subscriber decides the event to be recorded, either by highlighting the event in the IVG or by actually being tuned to the event in real-time, the subscriber then chooses from the recording options available for that event, such as video and closed captioning, via, for example, a remote control, mouse, or icon, the recording options available. The chosen options are then indicated to the processor 620 for recording.

The DHCT 600, based on the information received from the subscriber input from the recording options screen (FIG. 5), provides to the processor 620 a signal indicative of the selected recording choice(s). Subsequently, the processor 620 controls a switch 612 that allows the chosen streams that include the specific packets within the entire transport stream through to a decryption device 640. The decryption device 640 decrypts scrambled events if the operator previously scrambled the recorded event. In some systems, decryption must occur prior to storage, as the cryptographic system is sensitive to time. In the above example regarding the choices for recording video and closed captioning data, the processor 620 enables the switch 612 to allow the video and certain data packets, but not the audio packets, associated with the chosen event within the real-time transport stream to pass to the decryption device 640. In this example, the subscriber will record the picture and the closed captioning associated with the event, and the audio packets will not be recorded. If a subscriber chooses to record only audio, the switch 612 would then be controlled to provide only the audio packets. The packets to be recorded are then provided to a storage, or memory, device 645. It will be appreciated that the storage device 645 can be memory within the DHCT 600 or another device, which may or may not be removable, such as a personal computer memory card international association (PCMCIA) device.

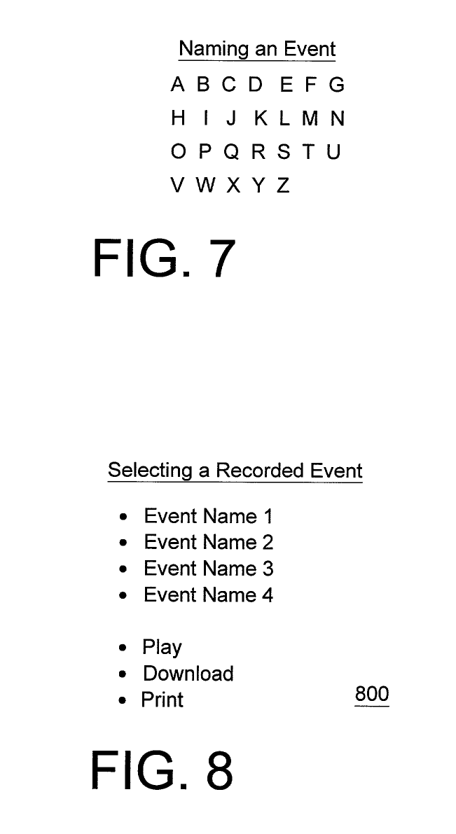

At the time of selecting the event and specific content streams to be recorded, the subscriber can also be allowed to name the event. FIG. 7 illustrates an example of one way to accomplish the function of naming an event. A table of the alphabet is displayed and the subscriber motions a cursor on the screen with a remote control to select a letter and add that letter to the event name. A wireless keyboard would be an alternative method of entering the information. When the name is complete, the event name is sent along with the content choices to the processor 620. When the processor 620 receives the event name, the event name is delivered to the storage device 645 and stored along with the chosen content streams. The allowed content choices are then stored under the event name within the storage device 645. The storage device 645 will store the event name and the recorded content streams until such time as the subscriber is ready to review the recording or until the subscriber erases, or deletes, the recording. Alternatively, the event name can be stored by obtaining the program name directly from the IVG data source. Traditional methods of handling the file structure within the storage medium may be applied.

Several methods can be used to implement the play feature within the DHCT 600. One way is to have a play button on the DHCT 600 itself similar to the play button on a VCR or on a remote control. Another example is to add a play option on an interactive screen displaying the list of recorded items on the television screen.

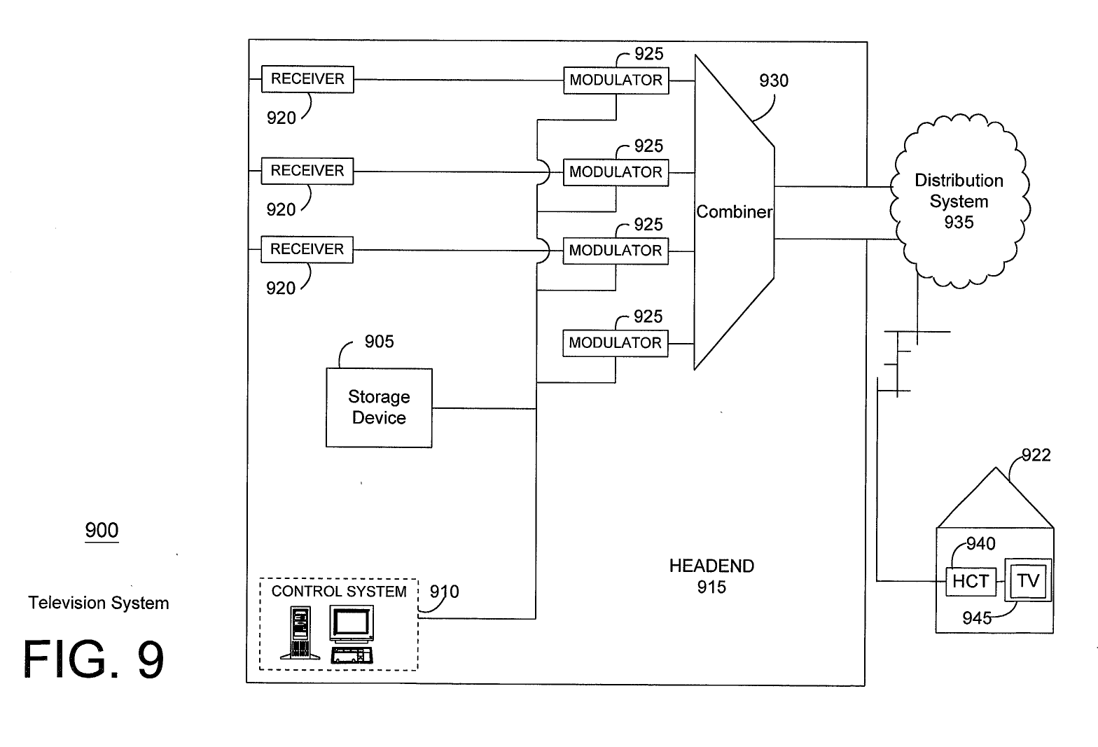

FIG. 8 illustrates a screen the subscriber can access on a television screen to select a recorded event for playback. The subscriber tunes to the Selecting a Recorded Event screen, such as by selecting a particular channel, pressing a button on the remote control, or selecting an icon shown on any channel, to access the interactive screen. The processor 620 receives the request to select a recorded event and queries the storage device 645 to provide all recorded event names to be shown on the Selecting a Recorded Event screen 800. Alternatively, a filter may be applied, for example, to display only events recorded within the past 24 hours. In addition, the display may also show the type of information contained within the event. In the above examples, the types “video” and “closed captioning” could be displayed (not shown). Once the list of recorded event names is retrieved and displayed on the screen, as shown in FIG. 8, options are then provided to the subscriber. For example, the subscriber can choose to play or output a recorded event that is currently stored in the storage device 645. Other options may include transferring a recorded event to another communication medium, such as a computer, via an auxiliary output port (not shown). The auxiliary output port can be a universal serial bus (USB) connector, a firewire IEEE 1394 connector, or wireless interface that mates with a computer, a television, a DHCT, or other consumer electronics device. It will be appreciated that supporting software within the computer or other personal device may be required. In the same manner, USB, firewire, or wireless interfaces can be used within the auxiliary output port to connect to a printer an thereby provide a print option. The print option may be used with HTML data, for example. Additional screens can be added that allow a subscriber to delete recorded events or to perform other functions associated with an event.

The above discusses recording an event that is sent downstream from the headend as part of scheduled programming and is accessed in real-time. In other words, the cable operator has already sent all the available content streams downstream. Another option that advantageously saves bandwidth for the cable operator is for a subscriber to choose recording or playing options prior to the content streams being sent downstream in an on-demand manner. For example, a subscriber may wish to view or record an event that an operator has previously recorded and is storing within a device at the headend.

FIG. 9 illustrates a communications system 900 that includes a storage device 905, such as a video-on-demand server. It will be appreciated that the video-on-demand server can store other types of information, such as audio and data, and are not constrained to storing video only. A control system 910 within the headend 915 is programmed to store all the streams included within popular events that are received from one of the receivers 920. The stored events may then be made available to subscribers on an on-demand basis. For example, the stored events can be shown on an IVG as events available to purchase or available under a subscription package. A subscriber 922 would select an event in the manner usually employed within video-on-demand systems, but additionally, in accordance with the present invention, would choose to view or record just the desired streams of the event. The processor 620 (FIG. 6) receives the command containing the selection from the user, which is typically an infrared (IR) control signal. The processor 620 sends the information from the user regarding the request through the cable network's reverse path to the control system 910. The control system 910 then instructs the storage device 905 to play the chosen information. The streams containing the chosen information are routed to a specific modulator 925 chosen at the time by the control system 910 for that task. The control system 910 sends a signal to the DHCT 940 through the usual means, telling the DHCT 910 that the desired streams will be supplied through the specific modulator 925 having an associated frequency. Upon receiving this instruction, the DHCT 940 then tunes the demodulator 610 to the frequency indicated in the message and the storage device 905 transmits the desired streams via modulator 925, a combiner 930, and a distribution system 935 to the subscriber 922. A receiver 940, such as a DHCT, receives the available choices associated with that event and that are indicative of the stored content streams. The subscriber can then choose from the available choices, and, instead of sending all the content streams associated with the stored event, the operator can selectively send just the desired streams at the appropriate time. The operator can then allocate the saved bandwidth within other areas of the system or to other users, thereby deriving additional revenues in the process. The subscriber 922 can then choose to record the event, immediately view the event, or both.

In summary, the selective recording device (SRD) 605 allows the subscriber choices in his or her recording selections. The choices depend upon the content streams that are available for each event. The subscriber can choose to record only streams of a real-time event, thereby saving memory space within the SRD 605. Additionally, if a subscriber chooses to record only a portion of the content streams associated with an event that the operator has previously recorded and stored, the operator may choose to save bandwidth by only sending the chosen content streams. Advantageously, this saved bandwidth can be allocated within other areas of the system or to other users, thereby allowing the operator to offer incentives or reducing rates to subscribers who choose to retrieve only portions of the entire content streams. An additional benefit to the subscriber is that the SRD 605 has the ability to record the content streams within the transport stream that can then be downloaded to a television, a computer, or a printer, and saving memory space in the personal devices.

What is claimed is:

1. A system for receiving information and for recording at least a portion of the information, the system comprising:
a processor for receiving multiple types of information, the processor including an output port for selectively transmitting the information for recording, an input port for receiving user commands, and a presentation port for transmitting the information for presentation to a user;
a presentation device coupled to the presentation port of the processor for receiving the information and presenting the information to the user;
a command unit including a transmitter coupled to the input port of the processor for providing recording commands to the processor and input means for receiving the recording commands from the user; and
a storage device coupled to the output port of the processor for receiving the information to be recorded and for storing the information,
wherein the recording commands indicate to the processor that at least one selected type of information has been selected for storage by the storage device, and wherein, upon reception of a recording command from the user, the command unit transmits the recording command to the processor, in response to which the at least one selected type of information is provided to the storage device, and wherein other non-selected types of information are not provided to the storage device for recording.

2. The system of claim 1, wherein the presentation device is a television.

3. The system of claim 1, wherein the command unit is an infrared remote control, and wherein the infrared remote control provides the recording command as an infrared control signal when associated buttons on the remote control are actuated.

4. The system of claim 1, wherein the multiple types information is included in a transport stream, the transport stream comprising at least one of:
audio streams;
video streams; and
data streams.

5. The system of claim 4, wherein the transport stream is an MPEG transport stream.

6. The system of claim 4, wherein the processor and the storage device are included within a set-top receiver, the set-top receiver including:
a demodulator for demultiplexing the incoming MPEG transport stream; and
a decoder for decoding and providing at least one of the audio streams, video streams, and data streams to the presentation device.

7. The system of claim 6, wherein the transport stream includes packet identifiers identifying the at least one audio streams, video streams, and data streams.

8. The system of claim 7, wherein the processor identifies available packet identifiers that represent available streams within the transport stream associated with an event and provides a menu to the user that is indicative to the available streams, wherein the user can choose at least one of the available streams for recording.

9. The system of claim 1, wherein the processor and the storage device are packaged as a stand-alone unit.

10. The system of claim 1, wherein the system operates in a broadband communications system.

11. The system of claim 1, wherein the broadband communications system includes:
a headend for generating the multiple types of information;
a distribution system for delivering the information.

12. The system of claim 11, wherein the distribution system is one of an optical fiber network, a coaxial cable network, a hybrid fiber-coaxial (HFC) network, a satellite system, an off-air VHF/UHF network, and a direct broadcast system.

13. A broadband communications system for transmitting and receiving a transport stream over a distribution system, wherein the transport stream includes video streams, audio streams, and data streams, the broadband communications system comprising:
a headend for generating the transport stream from multiple input sources;
a distribution system for delivering the transport stream;
a receiver for receiving the transport stream, the receiver comprising:
a demodulator for demultiplexing the incoming transport stream;
a processor coupled to the demodulator for receiving a portion of the transport stream, the processor including an output port for selectively transmitting the portion of the transport stream for recording, an input port for receiving user commands, and a presentation port for transmitting the portion of the information for presentation to a user;
a storage device coupled to the output port of the processor for receiving the portion of the transport stream to be recorded and for storing the portion of the transport stream;
a decoder coupled to both the demodulator and the processor for decoding at least one of the audio streams, video streams, and data streams;
a presentation device coupled to the decoder for receiving the at least one of the streams and presenting the streams to the user; and
a command unit including a transmitter coupled to the input port of the processor for providing recording commands to the processor and input means for receiving the recording commands from the user,
wherein the recording commands indicate to the processor that at least one of the selected streams has been selected for storage by the storage device, and wherein, upon reception of a recording command from the user, the command unit transmits the recording command to the processor, in response to which the at least one of the selected streams is provided to the storage device, and wherein other non-selected streams are not provided to the storage device for recording.

14. The broadband communications system of claim 13, wherein the transport stream is an MPEG transport stream.

15. The broadband communications system of claim 14, wherein the transport stream includes packet identifiers identifying the at least one audio streams, video streams, and data streams.

16. The broadband communications system of claim 15, wherein the processor identities the available packet identifiers that represent available streams within the transport stream associated with an event and provides a menu to the user that is indicative to the available streams, wherein the user can choose at least one of the available streams for recording.

17. The broadband communications system of claim 13, wherein the distribution system is one of an optical fiber network, a coaxial cable network, a hybrid fiber-coaxial (HFC) network, a satellite system, an off-air VHF/UHF network, and a direct broadcast system.

18. A broadband communications system for distributing information streams on demand in a playback mode that are related to an event and that comprise at least one of a video stream, an audio stream, and a data stream, and for further distributing identification information that identifies each stream related to the event, the broadband communications system comprising:
a transmitter for transmitting the information streams and the identification information;
a presentation device for receiving the information streams and the identification information and for presenting the identification information to a user;
a distribution system coupling the transmitter to the presentation device;
a user input device coupled to the presentation device for receiving a user command indicative of at least one stream that the user desires to have presented,
wherein an indication of the at least one stream is provided, via the distribution system, to the transmitter, in response to which the transmitter supplies the at least one stream, and no other unselected streams, to the presentation device.

19. The broadband communications system of claim 18, wherein the presentation device presents the at least one stream to the user.

20. The broadband communications system of claim 18, wherein the at least one stream is provided to a storage device for recording.
